(19) United States
(12) Patent Application Publication
(10) Pub. No.: US 2020/0125588 A1
(43) Pub. Date: Apr. 23, 2020

(54) Artificial Intelligence Driven Inference Engine to Separate Replicable from Non-Replicable Scientific Studies

(71) Applicant: Rupinder Bhatia, Southlake, TX (US)

(72) Inventor: Rupinder Bhatia, Southlake, TX (US)

(21) Appl. No.: 16/656,337

(22) Filed: Oct. 17, 2019

Related U.S. Application Data
(60) Provisional application No. 62/746,881, filed on Oct. 17, 2018.

(51) Int. Cl. G06F 16/28; G06F 16/25; G06N 20/00; G06F 16/248; G06N 7/00; G06F 16/2452; G06F 16/2458; G06F 16/2457

(52) U.S. Cl. CPC G06F 16/285; G06F 16/252; G06N 20/00; G06F 16/24578; G06N 7/005; G06F 16/24522; G06F 16/2465; G06F 16/248

(57) ABSTRACT

A method enables a user to separate replicable scientific studies from nonreplicable scientific studies to assist reasonable decision-making and scientific research. The method conducts an extensive search to acquire, filter, and sort various scientific studies related to the user's query entries and goals for any questions and/or problems. Using various artificial intelligence technologies and statistical modeling techniques, the method analyzes and evaluates each study and ranks the study based on a system generated evidential value. The method then uses the strongest replicable scientific study to recommend a path and/or course of action to the user as a solution for the user's queries and goals. Further, the method enables the user to make changes and/or adjustments to the specific course of action in real life based on the simulated outcome of the recommendation through a gamification module.

The current application claims a priority to the U.S. Provisional Patent application Ser. No. 62/746,881 filed on Oct. 17, 2018.

### FIELD OF THE INVENTION

The present invention relates generally to meta-analytic methods. More specifically, the present invention relates to a meta-analytic method and system that data-mines and refines a plurality of scientific studies using artificial intelligence and statistical models to separate replicable and non-replicable studies. Based on the most reliable and replicable scientific evidence thus generated with robust evidential value, the present invention can provide a best solution to a user addressed problem, and/or question.

### BACKGROUND OF THE INVENTION

As one of the 20th century's greatest philosophers of science, Karl Raimund Popper, once said, “Non-reproducible single occurrences are of no significance to science.” Replicability or Reproducibility is potentially a problem in all scientific fields. According to a January 2014 Nature article titled “NIH Plans to Enhance Reproducibility” by the US National Institutes of Health (NIH), “a growing chorus of concern, from scientists and laypeople, contends that the complex system for ensuring the reproducibility of biomedical research is failing and is in need of restructuring. As leaders of the US National Institutes of Health (NIH), we share this concern and here explore some of the significant interventions that we are planning.” Further, the same article states that “Science has long been regarded as ‘self-correcting’, given that it is founded on the replication of earlier work. Over the long term, that principle remains true. In the shorter term, however, the checks and balances that once ensured scientific fidelity have been hobbled. This has compromised the ability of today's researchers to reproduce others' findings.”

As generally observed in recent years, some scientific fields such as psychology, life sciences, and biomedicine, are facing replication crisis. For example, psychology was the first field to attempt large scale replication study of major research findings, but results ranged from 39% to 67% are discouraging. In another example, anecdotal evidence from the pharmaceutical industry suggested that exact replication success in the related field of drug development was found to be 11% and 26%. Recently, the replication crisis observed in the field of biomedicine, even though it was unlike the one shown in the field of psychology but had far more dire implications. Sloppy data analysis, contaminated lab materials, and poor experimental design all contributed to the problem. After reviewing the estimated prevalence of the flaws and fault-lines in biomedical literature, some scientists guessed that fully half of all results rested on shaky ground and might not be replicable. Additionally, many of cancer studies did not merely fail to find a cure, they might not offer any useful data whatsoever. Given current U.S. spending habits, scientists estimated that the resulting waste would amount to more than $28 billion. At the extreme, the probability of obtaining a significant result in an exact replication of an initially barely significant result can be close to that of a coin toss.

The replication crisis brought a deep problem, which is that much of scientific research in the lab—maybe even most of it—simply cannot be trusted. The data are corrupt. The findings are nonreproducible. The science does not work. Further, any business decision ranging from venture capital investments, merger and acquisition, to people's daily life choices based on such nonreplicable and nonreliable scientific studies may cause substantial problems. For example, a pharmaceutical conglomerate enterprise might purchase a startup company that boosted its stock price based on some novel findings which originated from scientific studies. But shortly after, the enterprise had to shut down the startup company mainly because the research studies did not replicate the initial results. This could have been predicted through systematic analysis and evaluation of the initial scientific studies to determine the publication bias and non-replicability. And likely, the low evidential value of the scientific studies of the startup company could have led to the contrary investment decision and the substantial financial loss and business failure could have been avoided.

Therefore, it is an objective of the present invention to provide a solution to aforementioned profound problems. The present invention offers a system and method to separate replicable scientific studies from nonreplicable scientific studies using artificial intelligence (AI) technologies and statistical modeling methods including natural language processing (NLP), data mining, p-curves, funnel plots, and various statistical tests. The method of the present invention allows a user to specify user query entries for any questions and/or problems. The user is also allowed to enter desired goals using the method of the present invention. The method subsequently conducts an extensive search to acquire, filter, and sort various scientific studies related to the user's query entries and goals. Using various AI and statistical techniques, the method analyzes and evaluates each of the relevant scientific studies and ranks them based on evidential values generated by the method. Additionally, the present invention processes and displays the strongest replicable scientific data as actionable advice, serves as the best, scientifically backed, solution for the user's queries and goals. Further, the method of the present invention enables the user to simulate the path and/or course of action recommended based on the analysis and evaluation for predictable outcome through a gamification module, which allows the user to make changes and/or adjustments to the specific course of action in real life to achieve goals.

### SUMMARY OF THE INVENTION

A method enables a user to separate replicable and non-replicable scientific studies to assist in decision making processes and scientific research using artificial intelligence (AI) technologies and statistical modeling methods including natural language processing (NLP), data mining, p-curves, funnel plots, and various statistical tests. The method addresses the detrimental impact of non-replicable scientific studies on decision making and scientific research, providing the user with the most credible and reliable sources of scientific data to ensure that the best study is chosen for decision making based on the user's inquiries and goals.

The method starts with the management of a user query form that allows a user to specify user query entries for any questions and/or problems. The user is also allowed to enter desired goals through the user query process. The method subsequently conducts an extensive search to acquire, filter, and sort various scientific studies related to the user's query entries and goals. Using various AI and statistical techniques, the method analyzes and evaluates each of the relevant scientific studies for replicability and reproducibility. Subsequently, the method ranks the scientific studies based on evidential values generated by the method. Additionally, the method sends each scientific study with corresponding ranking of evidential value to the user with specific determination of replicability. The method then uses the strongest and most credible sources of scientific study data to formulate an actionable plan, which serves as the best solution, scientifically backed, for the user's particular question and/or problem, and goals, to be addressed. The strongest results act as actionable advice based on high quality scientific studies with robust evidential value, leaving non-replicable and p-hacked scientific literature out of the equation. Further, the method of the present invention enables the user to simulate the path and/or course of action recommended based on the analysis and evaluation for predictable outcome through a gamification module, which allows the user to make changes and/or adjustments to the specific course of action in real life to achieve goals. Thus, the method enables the user to find whatever the user needs, where the results are based on all extracted scientific information from various external databases.

### BRIEF DESCRIPTION OF THE DRAWINGS

FIG. 1 is a block diagram illustrating the system overview of the present invention.

FIG. 2 is a flowchart illustrating the overall process followed by the method of the present invention.

FIG. 3 is a flowchart illustrating a sub-process of the present invention for prompting a specific user to enter at least one goal through the corresponding personal computing (PC) device.

FIG. 4 is a flowchart illustrating a sub-process of the present invention for conducting an extensive search.

FIG. 5 is a flowchart illustrating an alternative embodiment of the sub-process of the present invention for conducting an extensive search.

FIG. 6 is a flowchart illustrating another embodiment of the sub-process of the present invention for conducting an extensive search.

FIG. 7 is a flowchart illustrating a sub-process of the present invention for conducting study evaluation.

FIG. 8 is a flowchart illustrating an alternative embodiment of the sub-process of the present invention for conducting study evaluation.

FIG. 9 is a flowchart illustrating another embodiment of the sub-process of the present invention for conducting study evaluation.

FIG. 10 is a flowchart illustrating a sub-process of the present invention for a gamification module.

### DETAIL DESCRIPTIONS OF THE INVENTION

All illustrations of the drawings are for the purpose of describing selected versions of the present invention and are not intended to limit the scope of the present invention.

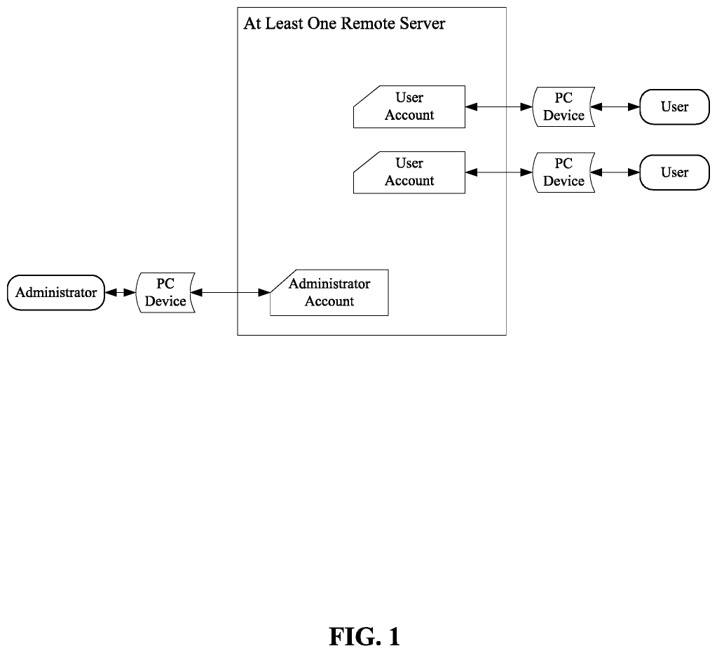

As can be seen in FIG. 1 to FIG. 10, the present invention is method and system for separating replicable and non-replicable scientific studies to assist in decision making processes and scientific research. More specifically, the method of the present invention addresses the gap between non-replicable scientific data and replicable scientific data, providing a user with the most credible and reliable sources of scientific data to ensure that the best study is chosen for decision making based on the user's inquiries and goals. Through an extensive search, the present invention acquires, filters, analyzes, evaluates, and ranks scientific studies. The resulted evaluation and ranking data are then used to further process and display the most credible actionable advice to the user. The strongest and most credible sources of data formulate actionable plan, which serves as the best solution for the user's particular question and/or problem to be addressed through the present invention. In the preferred embodiment of the present invention, the method enables the user to find whatever the user needs, where the results are based on all extracted scientific information from various external databases. The strongest results act as actionable advice based on high quality scientific studies with robust evidential value, leaving non-replicable and p-hacked scientific literature out of the equation.

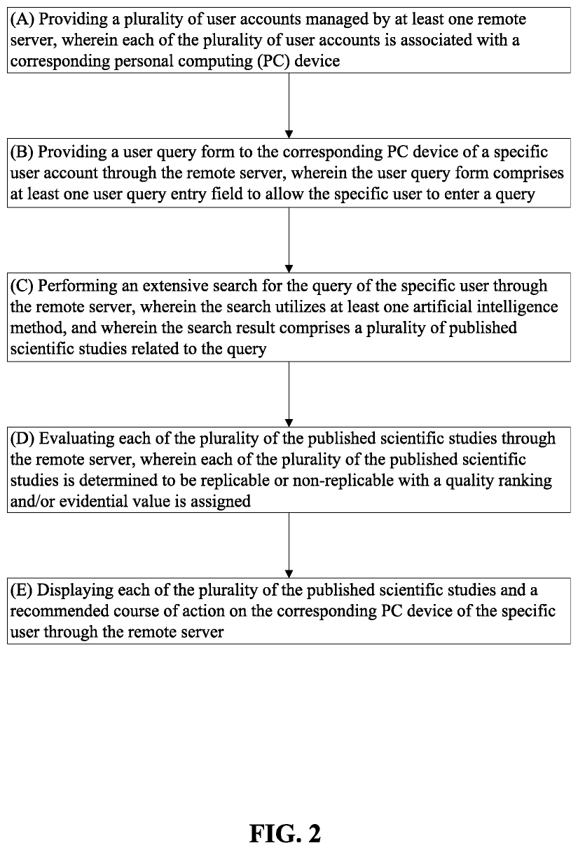

As can be seen in FIG. 1, the method of the present invention provides an online analysis and evaluation platform for scientific studies between a plurality of users. To accomplish this, the method of the present invention associates each of the plurality of users with a unique user account from a plurality of user accounts that is managed by at least one remote server (Step A), wherein each of the plurality of user accounts is associated with a corresponding user personal computing (PC) device, as seen in FIG. 1 and FIG. 2. The corresponding user PC device allows a user to interact with the present invention and can be, but is not limited to, a smartphone, a smart watch, a laptop, a desktop, a server computer, a tablet PC, etc. The users of the user accounts may include relevant parties such as, but are not limited to, individuals, consumers, scientists, educators, business owners, investment entities, venture capitalists, bankers, insurance agents and brokers, laboratories, institutions, research organizations, corporations, and administrators. Further, the at least one remote server is used to manage the online analysis and evaluation platform between the plurality of user accounts. The remote server can be managed through an administrator account by an administrator as seen in FIG. 1. Moreover, the remote server is used to execute a number of internal software processes and store data for the present invention. The software processes may include, but are not limited to, server software programs, web-based/cloud software applications or browsers embodied as, for example, but not be limited to, websites, web applications, cloud applications, desktop applications, and mobile applications compatible with a corresponding user PC device. Additionally, the software processes may store data into internal databases and communicate with external databases, which may include, but are not limited to, scientific study databases (such as Google Scholar®, CiteSeer®, Bioline International®, PubMed®, etc.), research databases, academic research databases, databases scientific journal articles, databases maintaining conference proceedings, databases maintaining research seminar publications, databases maintaining research reports, databases maintaining project reports, etc. The interaction with external databases over a communication network may include, but is not limited to, the Internet.

As can be seen in FIG. 2, the method used to execute the online analysis and evaluation of scientific studies of the present invention provides a user query form to the corresponding PC device of a specific user account through the remote server, wherein the user query form comprises at least one user query entry field to allow the specific user to enter a query (Step B). More specifically, the user query form serves as the user input module, allowing the user to enter user input query data to be further processed by the method of the present invention. In the preferred embodiment of the present invention, the user query form serves as the main portal for the user to enter at least one query field to specify any question/problem. The query entry provides search parameters for a plurality of scientific studies that will be used by the method to provide a solution to the user based on any specific goal that the user enters. Further, the query information can narrow the results based on user's particular question/problem. For example, in the field of weight loss and food choices, the specific user may enter a user query such as “Is ketogenic diet effective for weight loss for male adults?” In an alternative embodiment of the present invention, the method may comprise a questionnaire that allows the user to define the details of the question/problem, which include, but are not limited to, problem to be solved, field of scientific study, acceptable p-value, acceptable ranking, etc.

Once at least one user query is received, the method performs an extensive search for the query of the specific user through the remote server, wherein the search utilizes at least one artificial intelligence method, and wherein the search result comprises a plurality of scientific studies related to the query (Step C). Specifically, the method conducts an extensive search once the at least one user query has been initiated by the specific user and received by the system. Additionally, the method particularly works in conjunction with external databases to acquire, filter, and sort relevant scientific studies for the analysis and evaluation to solve the specific user's question/problem. Further, the method utilizes at least one artificial intelligence method to efficiently and effectively perform the search in the substantial amount of available scientific studies.

Subsequently, the method evaluates each of the plurality of the scientific studies through the remote server, wherein each of the plurality of the scientific studies is determined to be replicable or non-replicable with a quality ranking and/or evidential value is assigned (Step D). More specifically, the method performs analysis and evaluation for each of the plurality of the scientific studies to determine if the incumbent study is replicable or a non-replicable. Utilizing a plurality of statistical tools, the method statistically analyzes the plurality of scientific studies to separate replicable from non-replicable studies. Further, the method ranks the order of quality of each scientific study in order to devise a course of action based on the best replicable scientific study among the plurality of scientific studies. In the preferred embodiment of the present invention, the method of the present invention ranks each of the plurality of scientific studies based on quality of evidential value from lowest quality to highest quality.

Upon the completion of the analysis and evaluation of the plurality of scientific studies, the method displays each of the plurality of the scientific studies and a recommended course of action on the corresponding PC device of the specific user through the remote server (Step E). More specifically, the method relays each of the plurality of scientific studies found and ranked to the specific user through the remote server. Additionally, a course of action based on the outcome of the analysis and evaluation of each of the plurality of scientific studies is recommended to the specific user on the corresponding PC device and thus concluding the overall process of the method of the present invention.

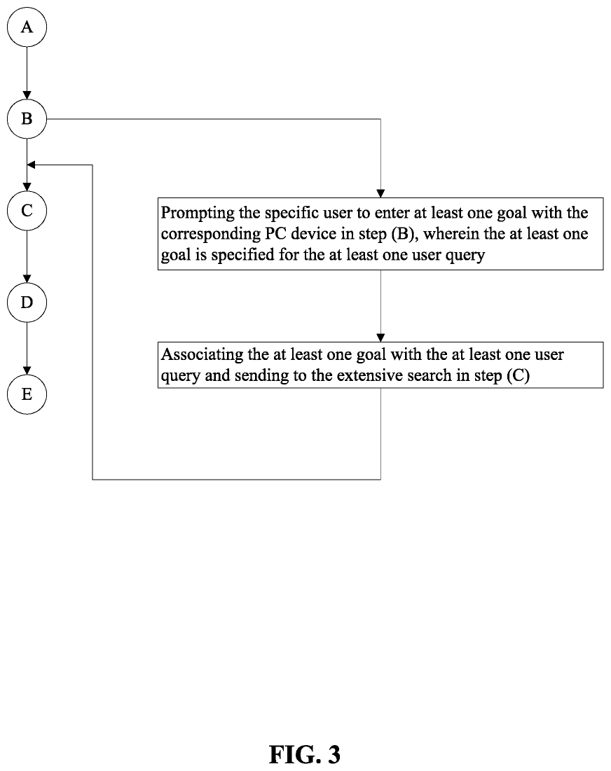

As can be seen in FIG. 3, in an embodiment of the present invention, the method provides an effective and convenient sub-process for the specific user to enter a desired goal. More specifically, the sub-process of the method prompts the specific user to enter at least one goal with the corresponding PC device in Step B, wherein the at least one goal is specified for the at least one user query, and the method associates the at least one goal with the at least one user query and sending to the extensive search in Step C. In this sub-process, the method allows the specific user to specify at least one desired goal related to the at least one user query. Continuing with the weight loss and food choices example, the specific user may enter a goal such as “to determine the best food choice for weight loss of male adults based on replicable and reliable scientific studies.”

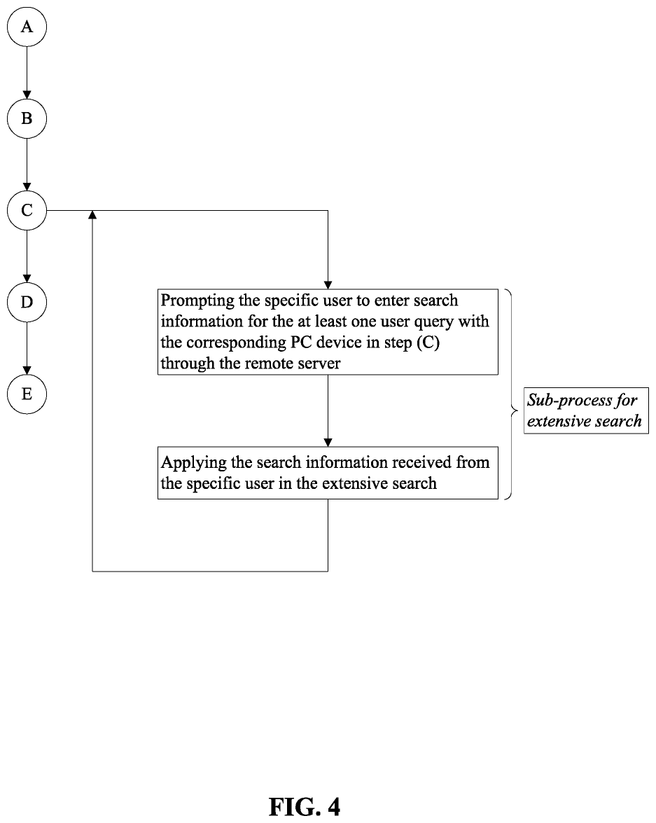

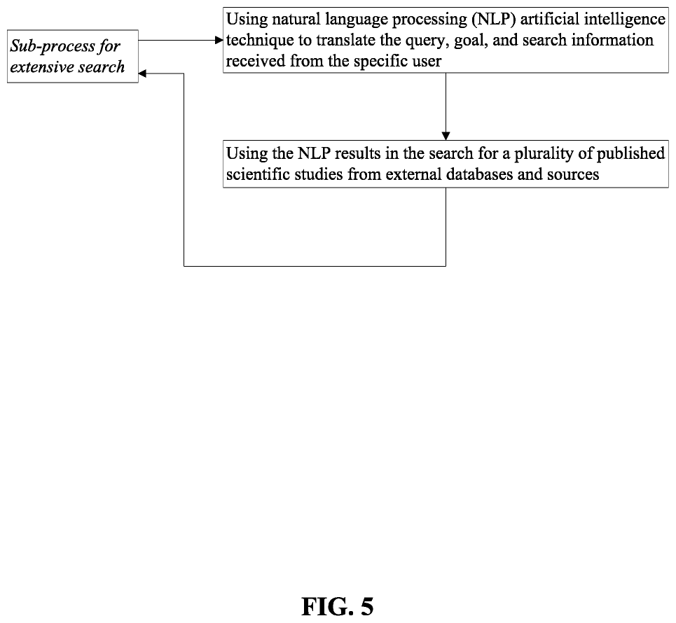

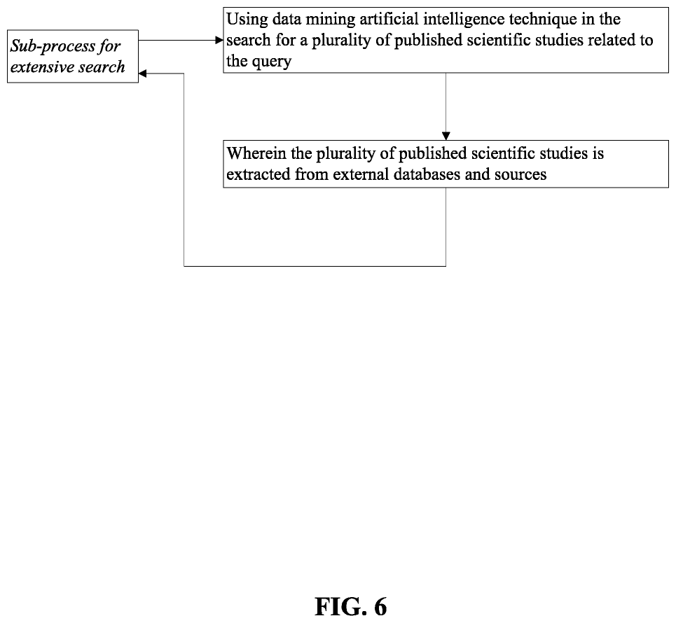

As can be seen in FIG. 4, in an embodiment of the present invention, the method provides a sub-process for the specific user to enter search parameters for the extensive search of the plurality of scientific studies related to the at least one user query. More specifically, the sub-process of the method prompts the specific user to enter search information for the at least one user query with the corresponding PC device in Step C through the remote server, and subsequently applies the search information received from the specific user in the extensive search. More specifically, the search information provided by the specific user helps the method narrow the range of searches and filter the vast amount of related scientific studies. Thus, the sub-process can improve the overall efficiency of the method of the present invention. As can be seen in FIG. 5, in another embodiment of the present invention, the method provides a sub-process for conducting the extensive search of the plurality of scientific studies related to the at least one user query. More specifically, the sub-process of the method uses natural language processing (NLP) artificial intelligence technique to translate the query, goal, and search information received from the specific user, and uses the NLP results in the search for a plurality of scientific studies from external databases and sources. The use of NLP artificial intelligence (AI) technique can provide an efficient and effective mechanism for the method to automate the search based on the at least one user entry and/or at least one associated goal expressed in a natural language. As can be seen in FIG. 6, in yet another embodiment of the present invention, the method provides a sub-process for conducting the extensive search of the plurality of scientific studies related to the at least one user query. More specifically, the sub-process of the method uses data mining artificial intelligence technique in the search for a plurality of scientific studies related to the query, wherein the plurality of published scientific studies is extracted from external databases and sources. The data mining AI technology used in the method provides effective functions including, but not limited to, classification, filtering, grouping, associating relevant scientific studies to be fed into the analysis and evaluation step, Step D, of the overall process of the method.

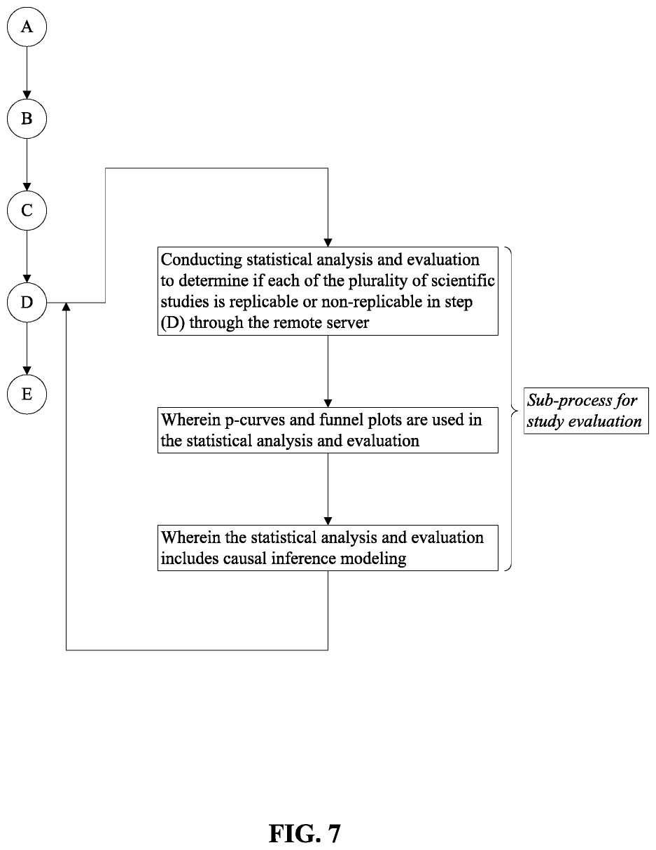

As can be seen in FIG. 7, in an embodiment of the present invention, the method provides a sub-process for analysis and evaluation of the plurality of scientific studies related to the at least one user query. More specifically, the sub-process of the method conducts statistical analysis and evaluation to determine if each of the plurality of scientific studies is replicable or non-replicable in Step D through the remote server, wherein p-curves and funnel plots are used in the statistical analysis and evaluation, and wherein the statistical analysis and evaluation includes causal inference modeling. Plotting p-values from the relevant scientific studies generates the quality of the evidential value. Only the right skewed p-curves, those with more low values, for example, 0.01, than high values, for example, 0.04, significant p-values are diagnostic of evidential value. P-curves that are not right skewed, suggest that the set of findings lack evidential value. P-curves that are left skewed suggest the presence of intense p-hacking. When studied effect is non-existent, which means that the null hypothesis is true, expected distribution of p-values of independent tests is uniform. A funnel plot is a visual representation of a data set and can reveal publication bias associated with scientific studies. Specifically, the funnel plot is a graphical representation of the size of trials plotted against the effect size that the trials report. Trials under study likely converge around the true underlying effect size as the size of the trial increases. And an even scattering of trials on either side of the true underlying effect is expected. Thus, a symmetrically inverted funnel plot arises from the data set where publication bias is unlikely, while an asymmetric funnel plot suggests possibility of publication bias and needs further investigation and evaluation of the incumbent scientific study. Causal inference method, developed by Judea Pearl, is a process of drawing a conclusion from observational studies. The conclusion normally relates to a causal connection based on the conditions of the occurrence of an effect. A causal inference for a scientific study analyzes the response of the effect variable when the cause is changed. The causal inference method identifies the cause or causes of a phenomenon under study by establishing covariation of cause and effect, a time-order relationship with the cause preceding the effect, and the elimination of plausible alternative causes to reach a reasonable conclusion. By using various mathematical and statistical techniques including, but not limited to, randomization, intervention, direct and indirect effects, confounding, counterfactuals, and attribution, potential-outcome framework, path diagram, etc., the casual inference method can offer researchers a powerful and comprehensive methodology of empirical research.

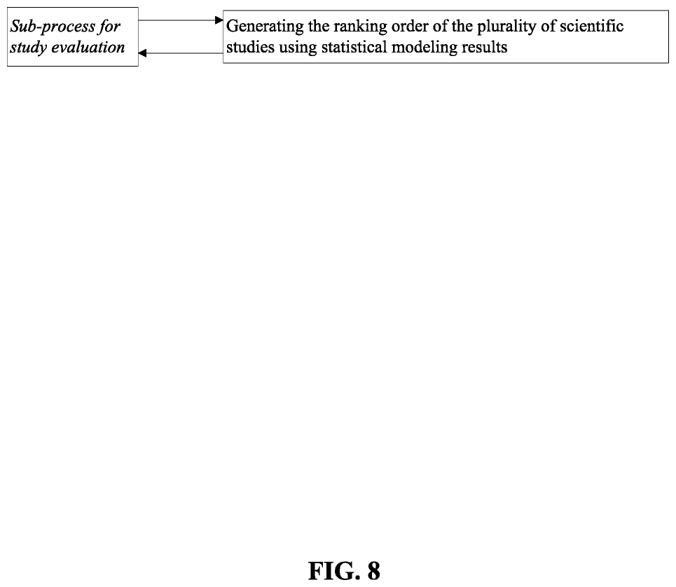

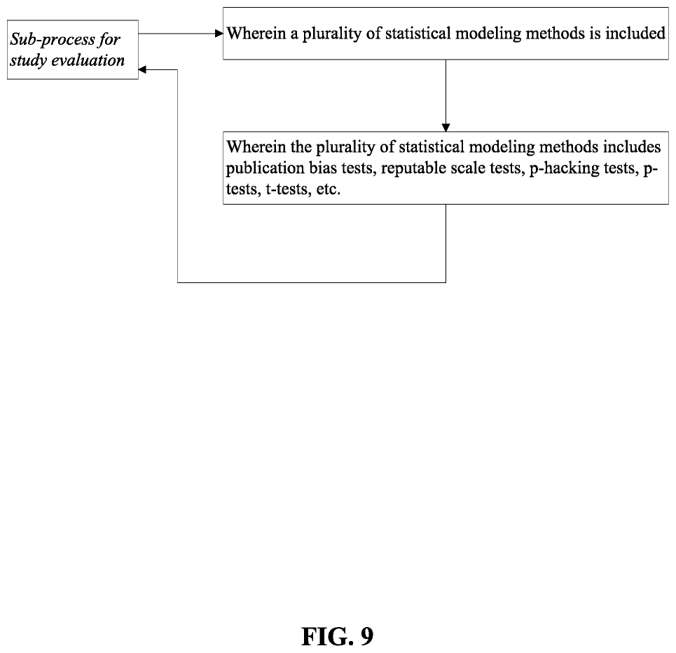

As can be seen in FIG. 8, the sub-process generates the ranking order of the plurality of scientific studies using statistical modeling results. Each of the plurality of scientific studies is ranked for scientific evidential value based on the statistical modeling results including, but not limited to p-curves, funnel plots, reputable scale tests, p-hacking tests, publication bias statistical tests, and any other viable statistical means. As can be seen in FIG. 9, in another embodiment of the present invention, the method provides a sub-process for analysis and evaluation of the plurality of scientific studies related to the at least one user query. More specifically, the sub-process of the method conducts statistical analysis and evaluation to determine if each of the plurality of scientific studies is replicable or non-replicable in Step D through the remote server, wherein a plurality of statistical modeling methods is included, and wherein the plurality of statistical modeling methods includes publication bias tests, reputable scale tests, p-hacking tests, p-tests, t-tests, etc. Further, the resulting statistics form the modeling methods provide additional support to the method for ranking the order of the plurality of scientific studies.

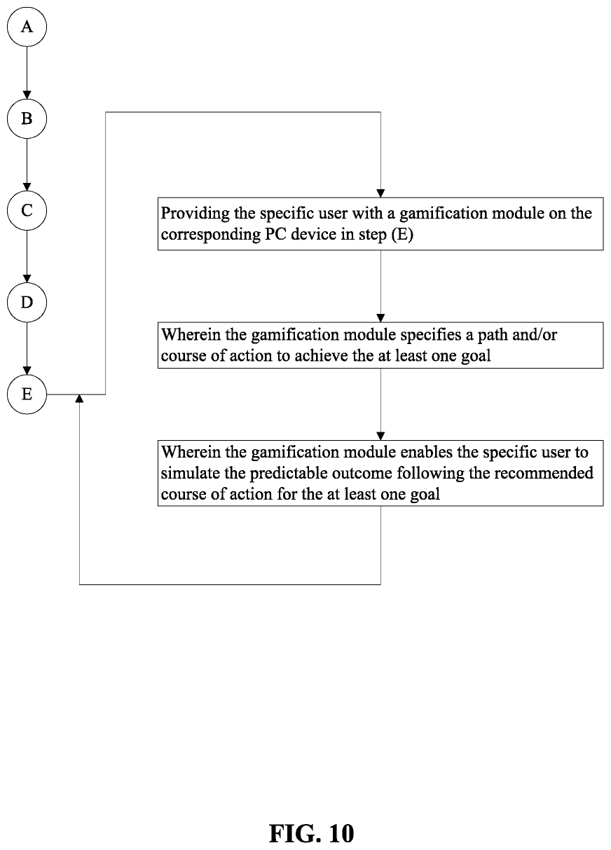

As can be seen in FIG. 10, in an embodiment of the present invention, the method offers the specific user a gamification sub-process. More specifically, the sub-process of the method provides the specific user with a gamification module on the corresponding PC device in Step E, wherein the gamification module specifies a path and/or course of action to achieve the at least one goal, and wherein the gamification module enables the specific user to simulate the predictable outcome following the recommended course of action for the at least one goal. The gamification module of the method guides the specific user to implement the calculated path and/or course of action through reminders, education, community engagement, notifications, tracker, meta-layer, and/or any other suitable method in keeping the specific user focused on achieving the predictable outcome and desired goal.

Although the invention has been explained in relation to its preferred embodiment, it is to be understood that many other possible modifications and variations can be made without departing from the spirit and scope of the invention as hereinafter claimed.

What is claimed is:

1. A method for separating replicable and non-replicable scientific studies to assist in decision making and scientific research, the method comprising the steps of:
(A) providing a plurality of user accounts managed by at least one remote server, wherein each of the plurality of user accounts is associated with a corresponding personal computing (PC) device;
(B) providing a user query form to the corresponding PC device of a specific user account through the remote server, wherein the user query form comprises at least one user query entry field to allow the specific user to enter a query;
(C) performing an extensive search for the query of the specific user through the remote server, wherein the search utilizes at least one artificial intelligence method, and wherein the search result comprises a plurality of scientific studies related to the query;
(D) evaluating each of the plurality of the scientific studies through the remote server, wherein each of the plurality of the scientific studies is determined to be replicable or non-replicable with a quality ranking and/or evidential value is assigned;
(E) displaying each of the plurality of the scientific studies and a recommended course of action on the corresponding PC device of the specific user through the remote server.

2. The method for separating replicable and non-replicable scientific studies to assist in decision making and scientific research as claimed in claim 1, the method comprising the steps of:
prompting the specific user to enter at least one goal with the corresponding PC device in step (B), wherein the at least one goal is specified for the at least one user query; and
associating the at least one goal with the at least one user query and sending to the extensive search in step (C).

3. The method for separating replicable and non-replicable scientific studies to assist in decision making and scientific research as claimed in claim 1, the method comprising the steps of:
prompting the specific user to enter search information for the at least one user query with the corresponding PC device in step (C) through the remote server; and
applying the search information received from the specific user in the extensive search.

4. The method for separating replicable and non-replicable scientific studies to assist in decision making and scientific research as claimed in claim 1, the method comprising the steps of:
using natural language processing (NLP) artificial intelligence technique to translate the query, goal, and search information received from the specific user; and
using the NLP results in the search for a plurality of scientific studies from external databases and sources.

5. The method for separating replicable and non-replicable scientific studies to assist in decision making and scientific research as claimed in claim 4, the method comprising the steps of:
using data mining artificial intelligence technique in the search for a plurality of scientific studies related to the query; and
wherein the plurality of published scientific studies is extracted from external databases and sources.

6. The method for separating replicable and non-replicable scientific studies to assist in decision making and scientific research as claimed in claim 1, the method comprising the steps of:
conducting statistical analysis and evaluation to determine if each of the plurality of scientific studies is replicable or non-replicable in step (D) through the remote server;
wherein p-curves and funnel plots are used in the statistical analysis and evaluation; and
wherein the statistical analysis and evaluation includes causal inference modeling.

7. The method for separating replicable and non-replicable scientific studies to assist in decision making and scientific research as claimed in claim 6, the method comprising the steps of:
generating the ranking order of the plurality of scientific studies using statistical modeling results.

8. The method for separating replicable and non-replicable scientific studies to assist in decision making and scientific research as claimed in claim 6, the method comprising the steps of:
wherein a plurality of statistical modeling methods is included; and
wherein the plurality of statistical modeling methods includes publication bias tests, reputable scale tests, p-hacking tests, p-tests, t-tests, etc.

9. The method for separating replicable and non-replicable scientific studies to assist in decision making and scientific research as claimed in claim 1, the method comprising the steps of:
providing the specific user with a gamification module on the corresponding PC device in step (E);
wherein the gamification module specifies a path and/or course of action to achieve the at least one goal; and
wherein the gamification module enables the specific user to simulate the predictable outcome following the recommended course of action for the at least one goal.
